(19) United States
(12) Patent Application Publication
(10) Pub. No.: US 2006/0021670 A1
(43) Pub. Date: Feb. 2, 2006

(54) Grain handling device and method of its use

(76) Inventor: Roger Baber, Galvaston, IN (US)

Correspondence Address: Jerry K. Mueller, Jr.;Mueller and Smith, LPA, 7700 Rivers Edge Drive, Columbus, OH, 43235, US

(21) Appl. No.: 10/909,671

(22) Filed: Aug. 2, 2004

(51) Int. Cl. A01C 1/00; G01F 11/00

(52) U.S. Cl. 141/2; 141/286

(57) ABSTRACT

The step-down device is an apertured round pipe that has slanted steps periodically disposed along the vertical length of the pipe interior and which only radially extend a short distance into the pipe interior. The slanted steps, which may be located on alternate (opposite) sides of the pipe interior, force the seed to cascade down the pipe bouncing off the steps and interior of the pipe. The step spacing determines the total all distance of the seed, which is insufficient to cause damage to the falling seed. The vertically spaced-apart apertures permit the seed to flow out from the pipe interior into the bin when the level of seed in the bin reaches each aperture.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention generally relates to the handling of seed and more importantly to a step-down for use in transferring seed to hoppers without damage to the seed.

Kernels of, for example, corn or soybean (“seed”) for planting are very fragile, being susceptible to mechanical damage. A tiny stress crack in the seed will prevent it from germinating and/or growing to its full potential. Therefore, seed companies are very careful how they handle seed, which leads to the use of a so-called “step-down” device.

There is a finite limit as to how far a seed can drop in a bin or hopper without risk of damage. This is particularly true when the process is initiated to fill the bin and there are no other seeds to cushion the dropping seed from hitting the bottom floor of the bin. A step-down or forced cascading device is inserted to limit the vertical drop height, yet still permit the bin to be filled.

Heretofore, U.S. Pat. No. 3,926,290 proposes a tubular telescoping loading chute for loading granules into a cargo vessel where the chute has internally disposed alternating rays for limiting the vertical distance that the particulates can drop.

U.S. Pat. No. 1,133,436 proposes a tubular fruit picker conveyor having alternating inclined plates for limiting the vertical distance that the fruit falls to prevent bruising.

U.S. Pat. No. 5,080,873 proposes an apparatus for growing crystals, which includes a tubular pipe having internally disposed alternating baffle plates that limit the vertical distance that the crystals can drop.

U.S. Pat. No. 1,230,820 proposes a tubular chute for unloading concrete, which has internally disposed alternating baffle plates.

These proposals do not relate to handling seed and do not show the inventive device.

### BRIEF SUMMARY OF THE INVENTION

The new step-down device is an apertured round (oval or circular in cross-section) pipe that has slanted steps periodically disposed along the vertical length of the pipe interior and which only radially extend a short distance into the pipe interior. The slanted steps, which may be located on alternate (opposite) sides of the pipe interior, force the seed to cascade down the pipe bouncing off the steps and interior of the pipe. The step spacing determines the total all distance of the seed, which is insufficient to cause damage to the falling seed. The vertically spaced-apart apertures permit the seed to flow out from the pipe interior into the bin when the level of seed in the bin reaches each aperture.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a perspective elevational cut-away view of a grain bin having the inventive step-down device in operating position inside the bin for loading the bin with grain;

FIG. 2 is a side cross-sectional elevational view of the bin and step-down device depicted in FIG. 1, with grain being poured into the step-down device for filling the bin with grain;

FIG. 3 is a side cross-sectional elevational view of the step-down device depicted in FIG. 1;

FIG. 4 is an overhead view of the step-down device depicted in FIG. 1; and

FIG. 5. is a side cross-sectional elevational view of the step-down device without grain outlet apertures for conveying grain from one location to another.

These drawings will be described in greater detail below.

### DETAILED DESCRIPTION OF THE INVENTION

The principle of the inventive grain step-down device is to create a plurality of small “waterfalls”, so that the grain does not free fall too far before contacting a step, which slows the velocity of the grain. Damage to the grain is minimized, if not precluded, by breaking up long vertical distances into a series of short distances. The grain, then, is not subjected to the violent crushing of long free-fall with attendant grain kernel damage.

Key to the inventive grain step-down device is that it is round. It can be fabricated from any length of pipe up to, say, 40 feet in length, and welded together to make any overall device length; and width from, say, 6″ or smaller, to 8″, 10″, 12″, or even larger, especially to rapidly handle larger volumes of grain. Current step-down devices are square and heavy, and occupy a lot of room. When grain falls through such square devices, a lot of the individual kernels are caught in the interior square corners, resulting in grain loss and waste. The inventive round step-down device has no interior square corners to catch the grain. It is easy to weld round pipe sections together to make a strong step-down device that is easy to clean and install.

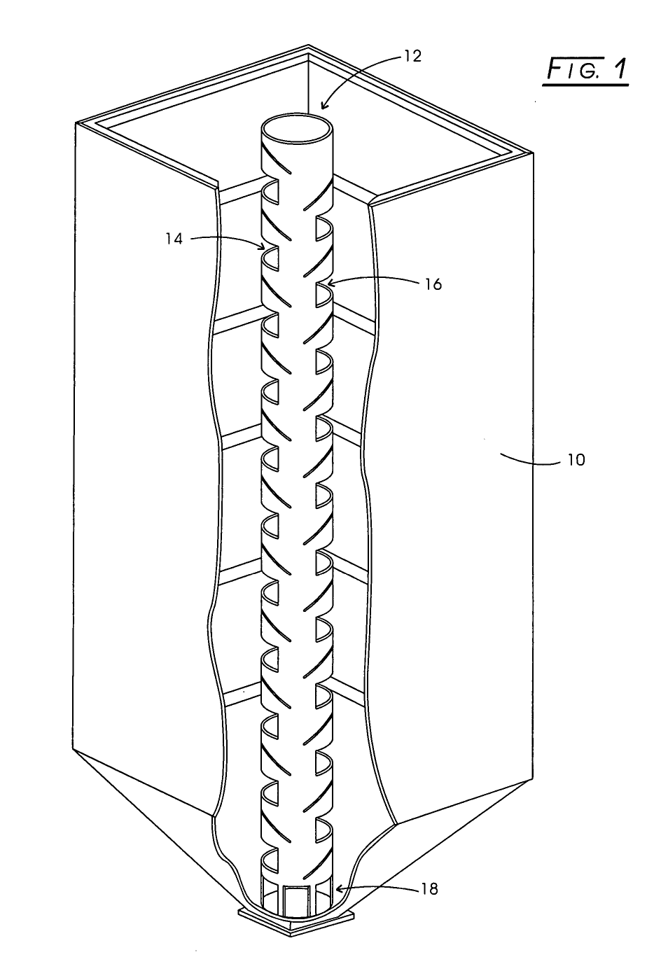

Referring to FIG. 1, a grain bin or hopper, 10, is cut-away to reveal novel round (circular or oval in cross-section) grain step-down device, 12, in position for loading bin 10 with grain. Bin 10 may be conventional in height ranging from, say 10 feet to about 40 feet or more; and can range in width from, say, around 4 feet to around 40 feet. Step-down device 12 also can be made in such lengths. Step-down device 12 is seen to have a multiplicity of apertures, such as an aperture, 14, disposed along the elongate or vertical length of device 12 and disposed oppositely, for example, aperture 14 and an aperture, 16, disposed on opposite sides of device 12. These apertures permit grain inside device 12 to flow from the interior of device 12 to outside device 12 and into the interior volume of bin 10 for its filling. The bottom of device 12, as at end 18, may have additional grain apertures to ensure that device 12 is completely emptied. Device 12 typically is welded in place in bin 10.

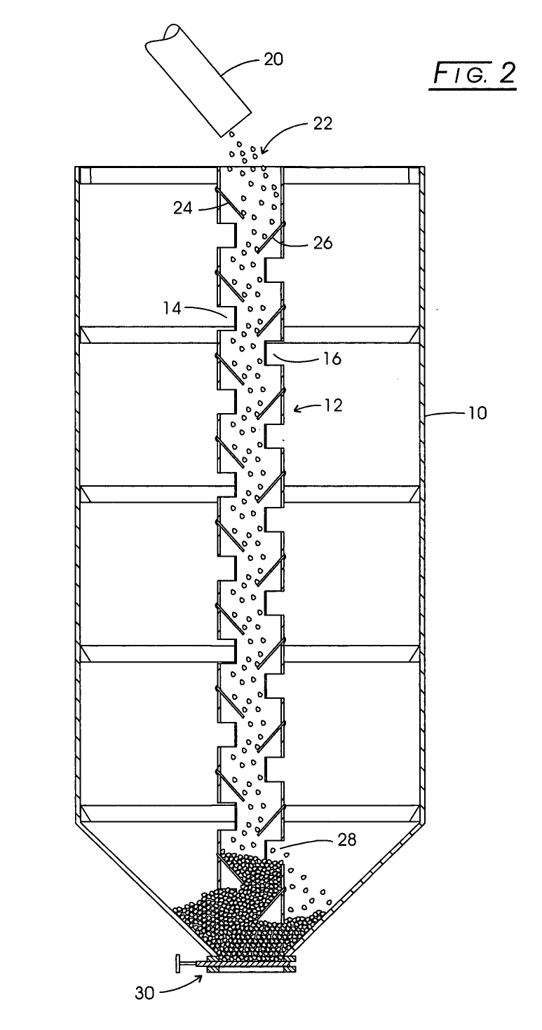

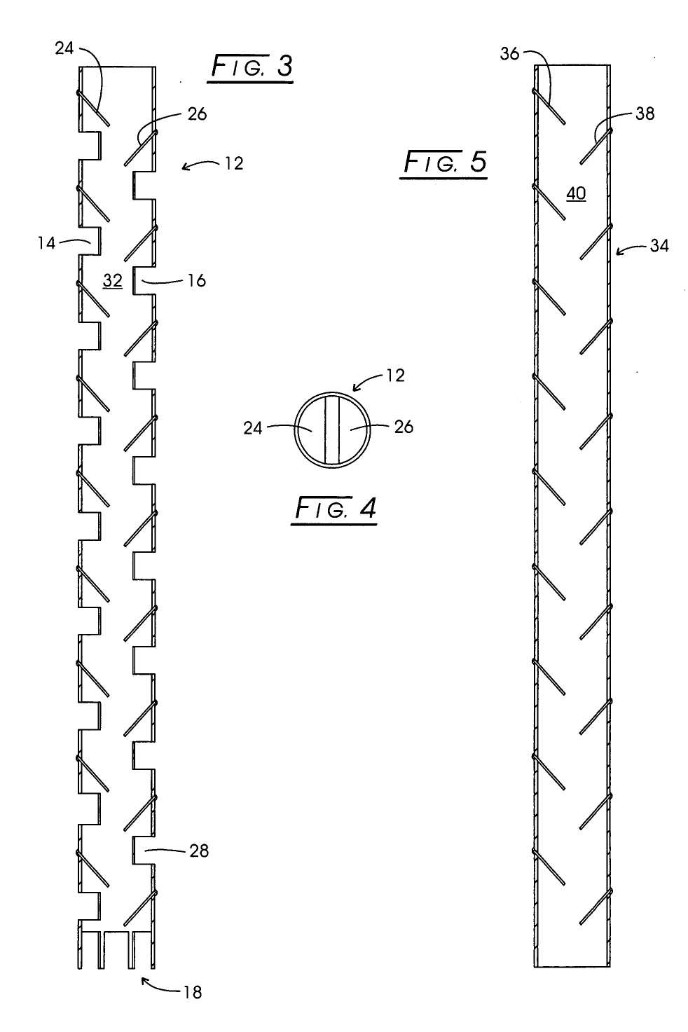

Referring now to FIGS. 2, 3 and 4 also, a pipe, 20, is seen directing grain, 22, into device 12 for filling bin 10. Disposed interiorly along with lengthwise extent of device 12 are a series of steps, for example, 24 and 26, which desirably are alternatingly oppositely disposed within the interior, 32 (see FIG. 3) of device 12 at intervals ranging from about 10 to about 20 inches, or more or less. This same spacing applies for the apertures also. Grain 22 flows into interior 32 of device 12 and much of it sequentially contacts each alternating step to slow down the rate of fall of grain 22 for minimizing damage to it. Steps 24 and 26 also are slanted inwardly and downwardly to direct the flow of grain onto each subsequent lower step. Device 12 typically is cut and steps 24 and 26 slid in through the cuts and welded at the exterior surface of device 12; although, other modes of attachment can be utilized. As grain 22 reaches the bottom or lower end of device 12, it can flow out of interior 32 of device 12, such as through an aperture, 28, and into the interior of bin 10 for its filling. As bin 12 becomes filled with grain 22, successively higher apertures direct grain 22 from device 12 and into bin 10.

It should be observed at this point in the description that device 12 can be removable from bin 22, especially if bin 22 is small, or it (most commonly) can be permanently installed in bin 10. For example, bin 22 has a gate assembly, 30, at its lower end for grain 22 to be discharged from bin 22, say, and into a trailer for planting. Regardless, device 12 has flexibility in design and operation to permit its use as a removable or a permanent grain-handling device.

Referring now also to FIG. 5, a step-down device, 34, has no apertures, but still has alternating slanted interior steps, for example, 36 and 38, for grain to flow through the interior, 40, of device 34. Again, grain sequentially contacts each oppositely disposed slanted step as it flow downwardly through interior 40 of device 34. Device 34 can be used to transport grain from one location to another location, such as pipe 20.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the US system and all amounts and percentages are by weight, unless otherwise expressly indicated. Also, all citations referred herein are expressly incorporated herein by reference.

I claim:

1. A grain step-down device, which comprises:
(a) an round pipe having an interior; and
(b) a plurality of slanted steps alternatingly disposed along the vertical length of said pipe and which radially extend a short distance into the pipe interior, the step spacing being insufficient to cause damage to seed falling through said device.

2. The grain step-down device of claim 1, wherein said pipe has a plurality of spaced-apart apertures that permit grain to flow from said pipe interior to outside of said pipe.

3. The grain step-down device of claim 1, wherein said steps are welded to the pipe.

4. The grain step-down device of claim 1, which is formed form metal.

5. The grain step-down device of claim 1, wherein said steps are spaced-apart a distance ranging from about 10 to about 20 inches.

6. The grain step-down device of claim 1, which ranges in length from about 5 feet to about 40 feet.

7. The grain step-down device of claim 2, wherein said steps are welded to the pipe.

8. The grain step-down device of claim 2, which is formed form metal.

9. The grain step-down device of claim 2, wherein said steps are spaced-apart a distance ranging from about 10 to about 20 inches.

10. The grain step-down device of claim 2, which ranges in length from about 5 feet to about 40 feet.

11. Method for filling a bin with grain, which comprises the steps of:
(a) providing a grain step-down device having a upper open end and being formed from an round pipe having an interior; and a plurality of slanted steps alternatingly disposed along the vertical length of said pipe and which radially extend a short distance into the pipe interior, the step spacing being insufficient to cause damage to seed falling through said device; and
(b) pouring grain into said device upper open end to fill said bin with said grain.

12. The grain step-down device of claim 11, wherein said pipe has a plurality of spaced-apart apertures that permit grain to flow from said pipe interior to outside of said pipe.

13. The grain step-down device of claim 11, which is formed form metal and wherein said steps are welded to the pipe.

14. The grain step-down device of claim 11, wherein said bin is filled with one or more of corn or soybeans.

15. The grain step-down device of claim 11, wherein said steps are spaced-apart a distance ranging from about 10 to about 20 inches.

16. The grain step-down device of claim 11, which ranges in length from about 5 feet to about 40 feet.

17. The grain step-down device of claim 12, wherein said steps are welded to the pipe.

18. The grain step-down device of claim 12, which is formed form metal.

19. The grain step-down device of claim 12, wherein said steps are spaced-apart a distance ranging from about 10 to about 20 inches.

20. The grain step-down device of claim 12, which ranges in length from about 5 feet to about 40 feet.
